(19) United States
(12) Patent Application Publication
(10) Pub. No.: US 2009/0016779 A1
(43) Pub. Date: Jan. 15, 2009

(54) TONER CARTRIDGE, A TONER CARTRIDGE LOCKING APPARATUS, AND AN IMAGE FORMING APPARATUS HAVING THE SAME

(75) Inventor: In-hak Hwang, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/959,820

(22) Filed: Dec. 19, 2007

(30) Foreign Application Priority Data
Jul. 9, 2007 (KR) 2007-68677

(51) Int. Cl. G03G 15/08

(52) U.S. Cl. 399/258; 399/262

(57) ABSTRACT

A toner cartridge locking apparatus includes a toner cartridge housing unit formed in a main body of an image forming apparatus, a locking unit to lock a toner cartridge inserted in the toner cartridge housing unit in place, and an elastic member to elastically support the toner cartridge inserted in the toner cartridge housing unit in a discharging direction of the toner cartridge. A user can remove the toner cartridge without force, thus user convenience is enhanced. In addition, since excessive force is not required to remove the toner cartridge, damage to the toner cartridge is prevented.

### CROSS-REFERENCE TO RELATED APPLICATIONS

This application claims priority under 35 U.S.C. §119(a) from Korean Patent Application No. 10-2007-0068677, filed on Jul. 9, 2007, in the Korean Intellectual Property Office, the disclosure of which is incorporated herein by reference in its entirety.

### BACKGROUND OF THE INVENTION

1. Field of the Invention

The present general inventive concept relates to a toner cartridge and a toner cartridge locking apparatus to facilitate locking and unlocking of the toner cartridge, and an image forming apparatus having the same.

2. Description of the Related Art

When image forming apparatuses run out of toner, empty toner cartridges must be removed and replaced with new toner cartridges. In order to remove the empty toner cartridge from the image forming apparatus, a user must unlock a locking unit, which holds the toner cartridge in place.

There are many methods of locking the toner cartridge, however, a user generally pulls a handle mounted on the unlocked toner cartridge to remove the toner cartridge.

If the toner cartridge is tightly fixed in the locking unit, the user must remove the toner cartridge by pulling the toner cartridge with considerable force, causing inconvenience to the user.

Furthermore, if the user pulls the toner cartridge with considerable force, weak external connection parts of the toner cartridge which may be fragile due to poor design may be damaged, and consequently toner residue may leak from the toner cartridge.

### SUMMARY OF THE INVENTION

The present general inventive concept provides a toner cartridge and a toner cartridge locking apparatus having an enhanced structure to facilitate locking and unlocking of the toner cartridge, and an image forming apparatus having the same.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a toner cartridge locking apparatus including a toner cartridge housing unit formed in a main body of an image forming apparatus, a locking unit to lock a toner cartridge inserted in the toner cartridge housing unit, and an elastic member to elastically support the toner cartridge inserted in the toner cartridge housing unit in a discharging direction of the toner cartridge.

The elastic member may be formed in the toner cartridge housing unit, and the elastic member may include a conical spring.

The locking unit may include a guiding groove and a guiding protrusion complementarily formed on the toner cartridge and the toner cartridge housing unit, wherein the guiding groove may include an inserting section to insert the guiding protrusion and a locking section extending perpendicular to the inserting section.

The guiding groove may be formed on the toner cartridge, and the guiding protrusion may be formed on the toner cartridge housing unit. Alternatively, the guiding groove is formed on the toner cartridge housing unit, and the guiding protrusion may be formed on the toner cartridge. In this case, the guiding groove may be formed on a rotating handle mounted on the toner cartridge.

The locking unit may include a locking member insertably and retractably formed on the toner cartridge housing unit, and a locking elastic member to elastically support the locking member, and wherein when the toner cartridge is inserted, the locking member may support the back of the toner cartridge.

The locking member may include an inclined plane formed in an inserting direction of the toner cartridge and a restraining plane located in the discharging direction of the toner cartridge. The locking member is pressed by a user to discharge the toner cartridge.

The locking unit may include a locking member insertably and retractably formed on the toner cartridge, a locking elastic member to elastically support the locking member and to move the locking member in an advancing direction, and a locking groove formed on the toner cartridge housing unit to accommodate the locking member when the toner cartridge is inserted in the toner cartridge housing unit.

The locking member may include a lever whereby the locking member is removed from the locking groove.

The locking unit may include a malleable locking member formed on the toner cartridge, and a locking groove formed on the toner cartridge housing unit to accommodate the locking member when the toner cartridge is inserted in the toner cartridge housing unit.

The locking member may include a lever whereby the locking member is removed from the locking groove.

The foregoing and/or other aspects and utilities of the present general inventive concept may also be achieved by providing an image forming apparatus including a main body including a toner cartridge housing unit, a toner cartridge removably inserted in the toner cartridge housing unit, and a toner cartridge locking apparatus to lock the toner cartridge in place in the toner cartridge housing unit and to guide the discharge of the toner cartridge. The toner cartridge locking apparatus may include a locking unit to lock the toner cartridge in place in the toner cartridge housing and an elastic member to elastically bias the toner cartridge inserted in the toner cartridge housing unit

The foregoing and/or other aspects and utilities of the present general inventive concept may also be achieved by providing an image forming apparatus having a toner cartridge The image forming apparatus may include a toner cartridge housing unit to guide the toner cartridge to be mounted in a main body of the image forming apparatus, wherein the toner cartridge may be locked in the toner cartridge housing unit place by a locking unit, and may be elastically supported by an elastic member in the toner cartridge housing unit so that the toner cartridge protrudes in a discharging direction of the toner cartridge if the locking unit is unlocked. The toner cartridge may include a toner supply hole, to release toner from the toner cartridge to the image forming apparatus, formed close to the elastic member.

The toner cartridge may further include a rotating handle which is disposed on a side opposite the side of the toner cartridge facing the elastic member. The locking unit may elastically alternate between a locked position and an unlocked position.

The toner cartridge unit may include a guide projection formed on a portion of a body of the toner cartridge to face the elastic member, the guide projection inserted into the elastic member.

The guide projection may have a diameter smaller than an inner diameter of the elastic member.

The guide projection may have a length longer than a distance of the elastic member in a compressed position.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a perspective view illustrating a toner cartridge locking apparatus according an embodiment of the present general inventive concept;

FIG. 2 is a cross-sectional view illustrating the toner cartridge locking apparatus of FIG. 1;

FIGS. 3 to 5 are cross-sectional views illustrating a toner cartridge locking apparatus according another embodiment of the present general inventive concept;

FIGS. 6 to 8 are cross-sectional views illustrating a toner cartridge locking apparatus according another embodiment of the present general inventive concept; and

FIGS. 9 to 11 are cross-sectional views illustrating a toner cartridge locking apparatus according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

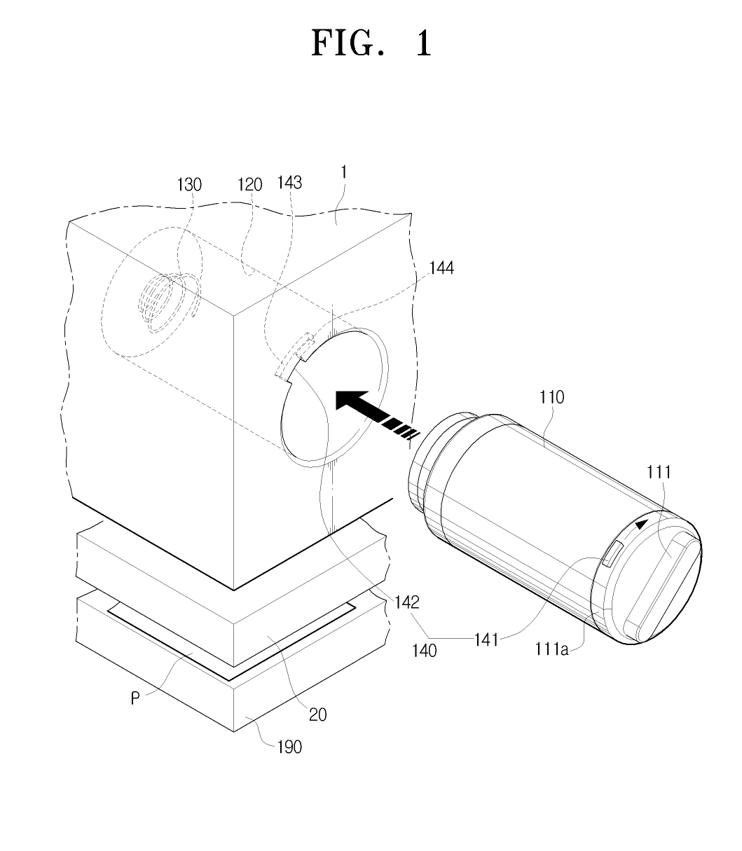

Referring to FIG. 1, an image forming apparatus according to the present general inventive concept includes a toner cartridge 110, a toner cartridge housing unit 120, an elastic member 130, and a locking unit 140. The image forming apparatus further includes a developing unit 20 to receive toner from the toner cartridge 110 and to form an image on a paper P fed by a paper feed unit 190. A conventional developing unit and a conventional paper feeding unit can be used as the developing unit 20 and the paper feed unit 190.

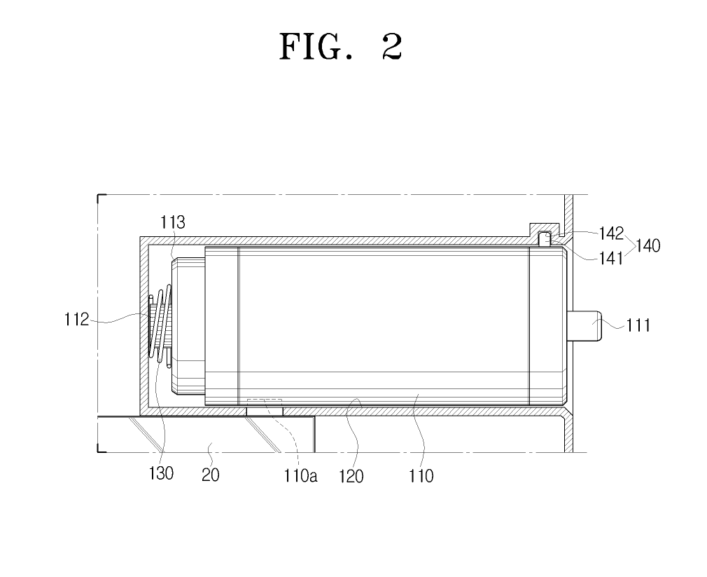

Referring to FIGS. 1 and 2, the toner cartridge 110 contains toner, and is inserted into and accommodated in the toner cartridge housing unit 120 mounted in a main body 1 of the image forming apparatus. A supply hole 110a to supply the toner from the toner cartridge 110 to the developing unit 20 is formed close to the elastic member 130 in the toner cartridge 110. When the toner cartridge 110 is inserted into the image forming apparatus, the force exerted upon the toner cartridge 110 is balanced by an equal and opposite force applied upon the toner cartridge 110 by the elastic member 130. Thus, the toner moves inside the toner cartridge 110 toward the supply hole 110a due to the two balanced forces being applied upon the toner cartridge 110 (i.e., due to the law of inertia). Consequently, the supply of the toner to the image forming apparatus is improved.

When the toner cartridge 110 is discharged from the image forming apparatus, a momentary acceleration is generated by the elastic member 130 and applied to the toner cartridge 110 to accelerate the toner cartridge 110 in a discharging direction (i.e., out of the toner cartridge housing 120). Thus in the same manner as when the toner cartridge 110 is inserted, the toner in the toner cartridge 110 leans toward the supply hole 110a due to the law of inertia, as described above, or a force by a user. Consequently, the supply of the toner to the image forming apparatus is improved.

The elastic member 130 is disposed between the toner cartridge 110 and the toner cartridge housing unit 120. The elastic member 130 may also be formed on the front of the toner cartridge 110, or the toner cartridge housing unit 120.

The elastic member 130 contacts and elastically biases the toner cartridge 110 inserted in the toner cartridge housing unit 120 in the discharging direction. In other words, if f the toner cartridge 110 is unlocked, the elastic member 130 causes the toner cartridge 110 to be automatically discharged from the main body 1.

The elastic member 130 may be a conical spring having an externally increasing diameter. When the elastic member 130 is fully compressed, the coil springs do not interfere with each other, and thus a large space is not required to accommodate the elastic member 130. The elastic member 130 may be formed either of a porous substance, such as urethane or sponge, or an elastic substance, which does not require a large space for compression, such as a leaf spring. However, the present general inventive concept is not limited thereto and any suitable porous or elastic substance may be utilized.

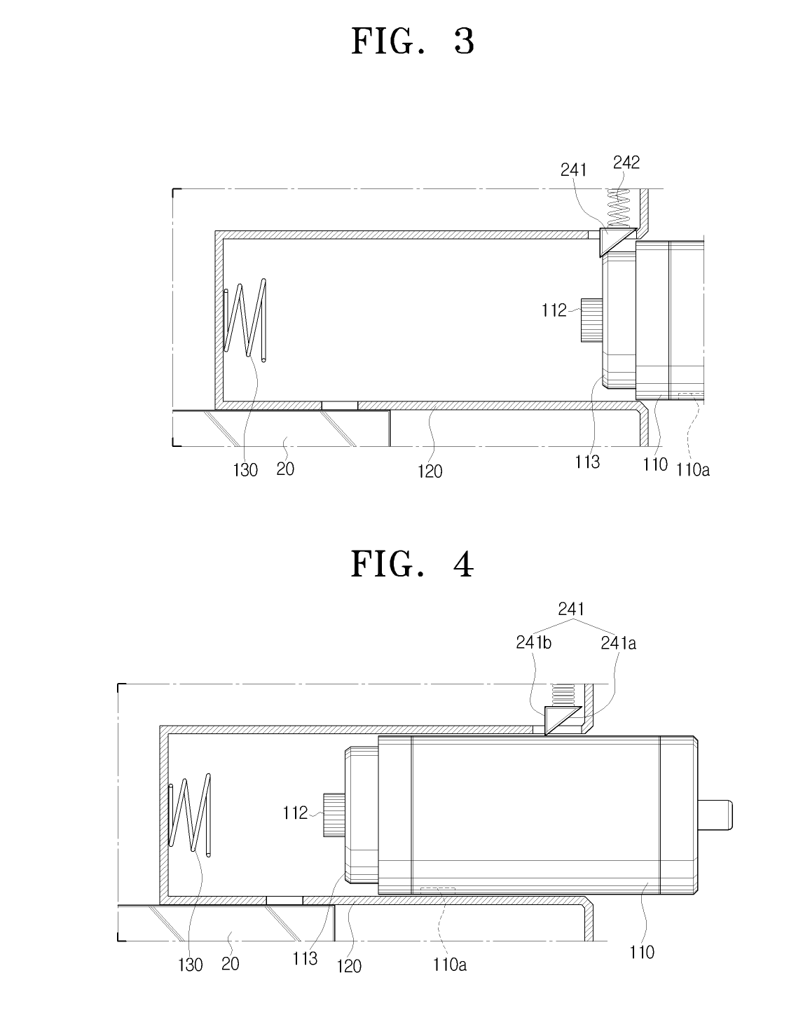

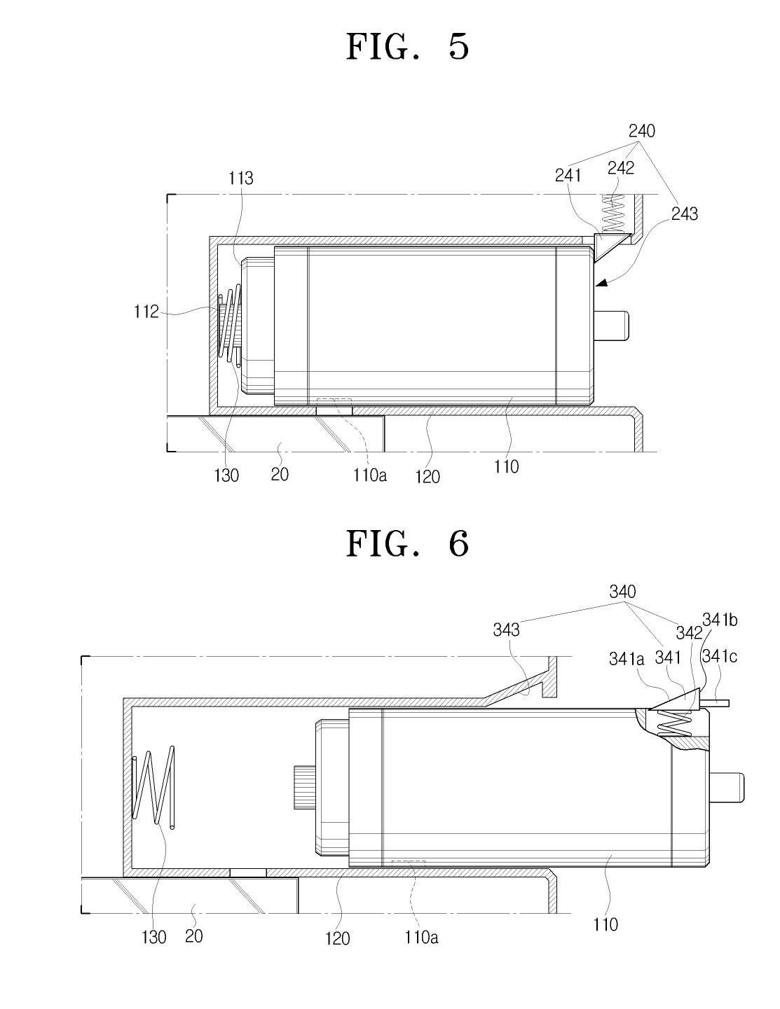

The toner cartridge 110 may include a surface 113 to face the elastic member 130 and a guide projection 112 protruding from the surface 113 to be inserted into an inside of the elastic member 130 as illustrated in FIGS. 2 to 5. The guide projection 112 may have a diameter smaller than an inner diameter of the elastic member 130. The guide projection 112 can be disposed inside the elastic member 130 in a compressed position and a normal (i.e., non-compressed position) of the elastic member 130. The guide projection 112 can have a length in an insertion direction to maintain a location of the supply hole 110a to supply toner to the developing unit 20.

The locking unit 140 according to an embodiment of the present general inventive concept holds the toner cartridge 110 in place in the toner cartridge housing unit 120. As illustrated in FIGS. 1 and 2, a guiding protrusion 141 and a guiding groove 142 are formed on the toner cartridge 110 and the toner cartridge housing unit 120, respectively. The guiding protrusion 141 protrudes from a rotation cover 111a having a rotating handle 111 which is formed on the toner cartridge 110. The guiding groove 142 is formed in the toner cartridge housing unit 120 and accommodates the guiding protrusion 141 when the toner cartridge 110 is inserted into the toner cartridge housing unit 120. Alternatively, the guiding protrusion 141 and the guiding groove 142 may also be formed on the toner cartridge housing unit 120 and the toner cartridge 110, respectively.

The guiding groove 142 includes an inserting section 143 which accommodates the guiding protrusion 141 and a locking section 144 to lock and secure the guiding protrusion 141 once the guiding protrusion 141 is inserted therein.

The inserting section 143 is extends from a location in which the toner cartridge 110 is inserted from the entrance of the toner cartridge housing unit 120 to the location in which the toner cartridge 110 is held in place. The locking section 144 is connected to the inserting section 143, and is formed perpendicular to the inserting section 143 extending along the circumference of the toner cartridge 110, in a direction that corresponds to the rotation of the rotating handle 111.

When the toner cartridge 110 is inserted, the user rotates the rotating handle 111 of the toner cartridge 110 in a direction of the arrow illustrated in FIG. 1. In particular, the direction of the arrow may be either clockwise or counterclockwise dependent upon the design of the toner cartridge. The rotation cover 111a is then rotated separately from the toner cartridge 110. The guiding protrusion 141 moves from the inserting section 143 to the locking section 144, and the toner cartridge 110 is securedly fixed inside the toner cartridge housing unit 120.

Referring to FIGS. 3 to 5, a locking unit 240 according to another embodiment of the present general inventive concept includes a locking member 241 and a locking elastic member 242. The locking member 241 supports a rear end 243 of the toner cartridge 110 when the toner cartridge 110 is inserted into the toner cartridge housing unit 120.

The locking member 241 is resiliently formed on the inner wall of the toner cartridge housing unit 120, and is disposed at a location to support the rear end 243 of the toner cartridge 110 when the locking member 241 advances in an upward direction toward the inside of the toner cartridge housing unit 120. When the toner cartridge 110 is being inserted, the locking member 241 is advances further toward the inner wall of the toner cartridge housing unit 120 due to the force of the toner cartridge 110 as it is inserted into the toner cartridge housing unit 120. Further, when the toner cartridge 110 is completely inserted, the locking member 241 retracts and abuts or supports the rear 243 of the toner cartridge 110. The locking member 241 is formed with an inclined plane 241a and a restraining plane 241b. The inclined plane 241a faces the toner cartridge 110 in a direction in which the toner cartridge 110 is inserted into the toner cartridge housing unit 120. The restraining plane 241b is formed diagonal to the inclined plane 241a, and supports the rear end 243 of the toner cartridge 110 as the toner cartridge 110 passes by the inclined plane 241a.

If a user presses the inclined plane 241a of the locking member 241 upwards, the restraining plane 241b will no longer restrain the rear end 243 of the toner cartridge 110, thus the locking unit 240 will unlock. As a result, the toner cartridge 110 is discharged in an outward direction away from the toner cartridge housing 120 due to the elastic expansion and force of the elastic member 130 exerted upon the toner cartridge 110.

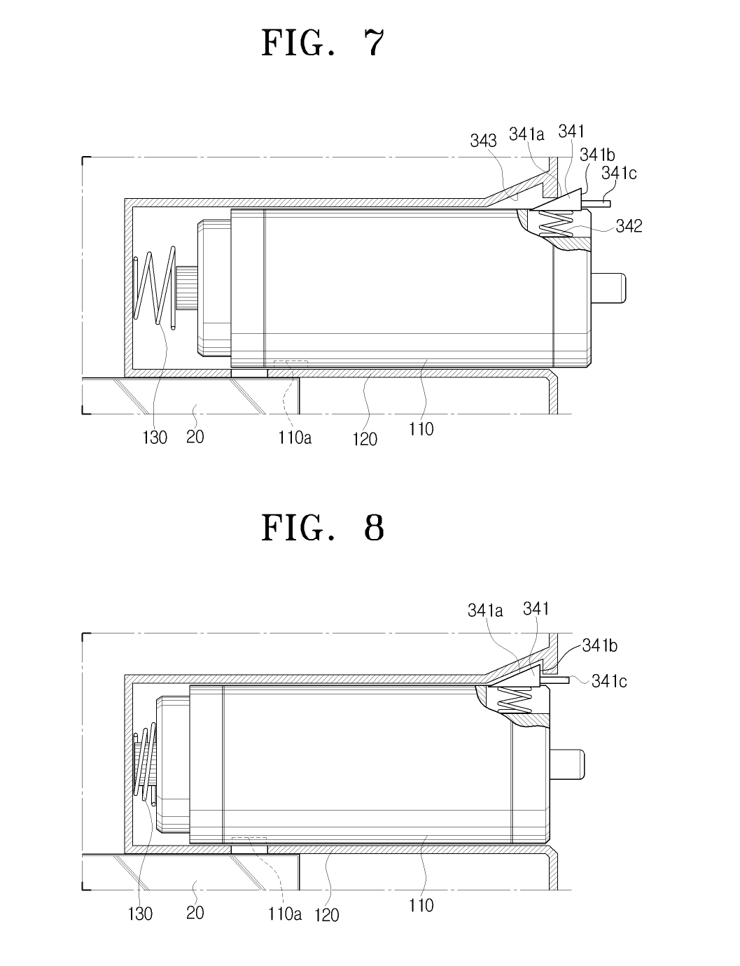

A locking unit 340 according to another embodiment of the present general inventive concept includes a locking member 341, a locking elastic member 342, and a locking groove 343, as illustrated in FIGS. 6 to 8.

The locking member 341 is insertably and retractably formed on the toner cartridge 110. Specifically, the locking elastic member 342 is disposed inside the toner cartridge 110 and elastically supports the locking member 341 from below.

The locking member 341 includes an inclined plane 341a, a restraining plane 341b, and a lever 341c. The inclined plane 341a faces the toner cartridge housing unit 120 in a direction in which the toner cartridge 110 is inserted. The restraining plane 341b is formed diagonal to the inclined plane 341a, and prevents the locking member 341 from slipping out of the locking groove 343 when the locking member 341 is inserted in the locking groove 343.

The locking groove 343 is formed on the toner cartridge housing unit 120 facing the locking member 341 and is formed having the contoured shape of the locking member 341. Thus, when the toner cartridge 110 is inserted, the locking groove 343 accommodates the locking member 341.

The lever 341c is integrally formed with the locking member 341, and extends from the locking member 341. If a user presses the lever 341c, the locking member 341 is removed from the locking groove 343 and accordingly, the toner cartridge 110 advances outwardly from the toner cartridge housing unit 120 due to the elastic force exerted by the elastic member 130 upon the toner cartridge 110.

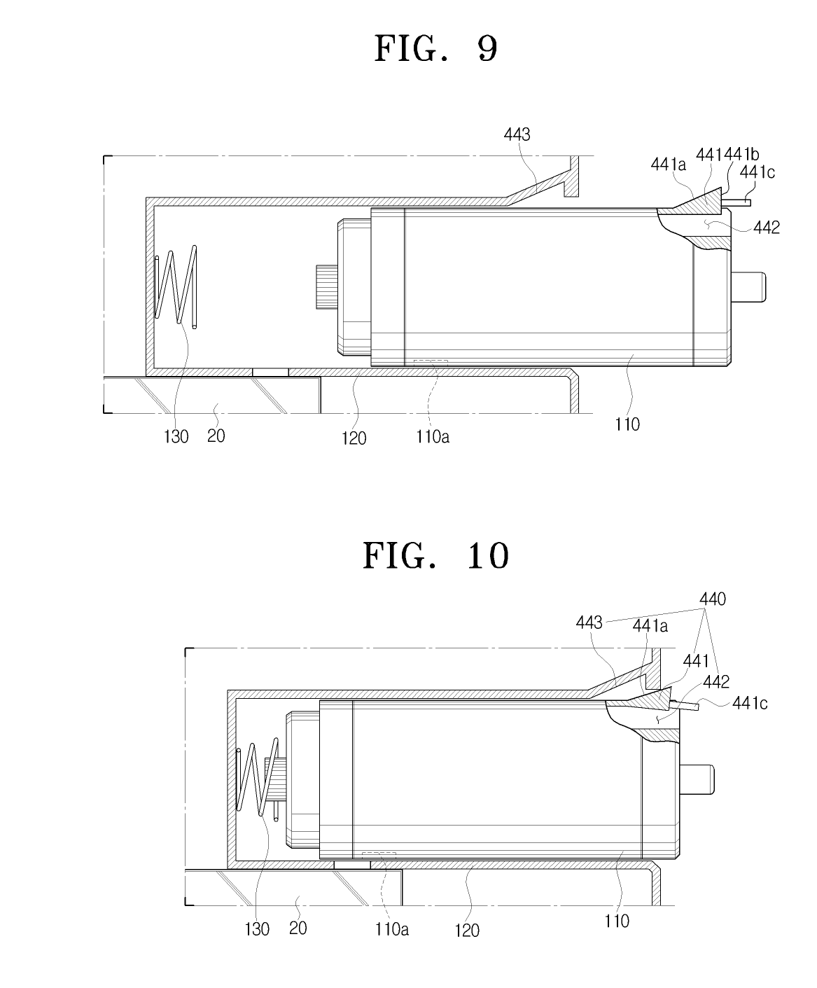

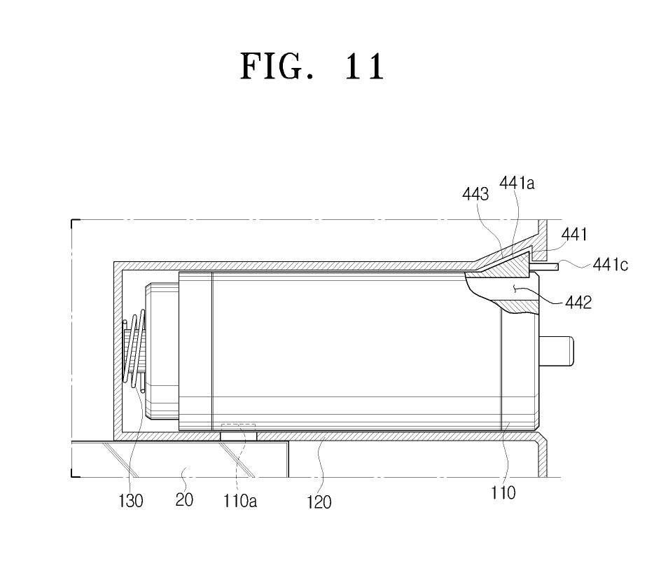

Referring to FIGS. 9 to 11, a locking unit 440 according another embodiment of the present general inventive concept comprises a locking member 441, and a locking groove 443.

The locking member 441 is malleable and resiliently formed on the toner cartridge 110. The toner cartridge 110 includes a space 442 under the locking member 441, so the locking member 441 can be resiliently compressed in the toner cartridge 110.

The locking member 441 includes an inclined plane 441a, a restraining plane 441b, and a lever 441c. The configuration of the locking member 441 is similar to the locking member 341 in the embodiment according to the present general inventive concept illustrated in FIGS. 6 to 8. However, the locking member 341 illustrated in the embodiment of FIGS. 6 to 8 is elastically supported by the locking elastic member 342 in the toner cartridge 110. Conversely, the locking member 441 in the present embodiment extends and protrudes from one end of the toner cartridge 110 and is formed on the toner cartridge 110 resiliently formed.

The locking groove 443 is formed in the toner cartridge housing unit 120 facing the locking member 341 and is formed having the contoured shape of the locking member 441. When the toner cartridge 110 is inserted into the toner cartridge housing unit 120, the locking groove 443 accommodates the locking member 441 to secure the toner cartridge 110 in the toner cartridge housing unit 120.

If a user presses the lever 441c, the locking member 441 is separated from the locking groove 443 and accordingly, the toner cartridge advances outward from the toner cartridge housing unit 120 due to elastic force exerted by the elastic member 130 upon the toner cartridge 110.

The image forming apparatus according to the present general inventive concept includes a main body 1, a toner cartridge 110, and a toner cartridge locking apparatus as described above.

The main body 1 includes a toner cartridge housing unit 120 to accommodate the toner cartridge 110 containing toner. Accordingly, toner is supplied to a developing unit 20 mounted in the main body.

The toner cartridge locking apparatus according to the present general inventive concept maintains the toner cartridge 110 in the toner cartridge housing unit 120, and guides the smooth discharge of the toner cartridge 110 from the toner cartridge housing unit 120.

As described above, an elastic member 130 is disposed between the toner cartridge 110 and the toner cartridge housing unit 120. Thus, If either of the locking units 140, 240, 340 and 440 according to the embodiments of the present general inventive concept are unlocked, the toner cartridge 110 is discharged from the toner cartridge housing unit 120 by a force of elastic member 130 being exerted upon the toner cartridge 110. Therefore, the user can easily remove the toner cartridge 110 from the toner cartridge housing unit 120.

Thus, the present general inventive concept among other things, eliminates inconvenience experienced by the user when forcefully pulling and removing the toner cartridge 110. In particular, when the user puts too much force on the toner cartridge, leaking of toner residue thereby causing soiling of the user's hands is eliminated. Additionally, the damage of weak or poorly-constructed external connection parts of the toner cartridge is eliminated.

As can be appreciated from the above description, the user can remove the toner cartridge without excessive destructive force, so user convenience is enhanced.

In addition, since excessive force is not required to remove the toner cartridge, the toner cartridge will not be damaged.

Moreover, when the toner cartridge is inserted or discharged, toner in the toner cartridge moves towards the supply hole so that the supply of the toner is improved.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A toner cartridge locking apparatus usable with an image forming apparatus comprising:
a toner cartridge housing unit formed in a main body of an image forming apparatus;
a locking unit to lock a toner cartridge inserted in the toner cartridge housing unit; and
an elastic member to elastically support the toner cartridge inserted in the toner cartridge housing unit in a discharging direction of the toner cartridge.

2. The toner cartridge locking apparatus of claim 1, wherein the elastic member is formed in the toner cartridge housing unit.

3. The toner cartridge locking apparatus of claim 2, wherein the elastic member comprises a conical spring.

4. The toner cartridge locking apparatus of claim 1, wherein the locking unit comprises a guiding groove and a guiding protrusion complementarily formed on the toner cartridge and the toner cartridge housing unit, respectively,
wherein the guiding groove comprises an inserting section to accommodate the guiding protrusion and a locking section extending perpendicular to the inserting section.

5. The toner cartridge locking apparatus of claim 4, wherein the guiding groove is formed on the toner cartridge, and the guiding protrusion is formed on the toner cartridge housing unit.

6. The toner cartridge locking apparatus of claim 4, wherein the guiding groove is formed on the toner cartridge housing unit, and the guiding protrusion is formed on the toner cartridge.

7. The toner cartridge locking apparatus of claim 6, wherein the guiding groove is formed on a rotating handle mounted on the toner cartridge.

8. The toner cartridge locking apparatus of claim 1, wherein the locking unit comprises a locking member insertably and retractably formed on the toner cartridge housing unit; and
a locking elastic member to elastically support the locking member and to move the locking member in an advancing direction of the locking member,
wherein when the toner cartridge is inserted, the locking member supports the back of the toner cartridge.

9. The toner cartridge locking apparatus of claim 8, wherein the locking member comprises an inclined plane formed in an inserting direction of the toner cartridge and a restraining plane formed in a discharging direction of the toner cartridge.

10. The toner cartridge locking apparatus of claim 9, wherein the locking member is pressed by a user to discharge the toner cartridge.

11. The toner cartridge locking apparatus of claim 1, wherein the locking unit comprises a locking member insertably and retractably formed on the toner cartridge;
a locking elastic member to elastically support the locking member and to move the locking member in an advancing direction ; and
a locking groove formed on the toner cartridge housing unit so as to accommodate the locking member when the toner cartridge is inserted in the toner cartridge housing unit.

12. The toner cartridge locking apparatus of claim 11, wherein the locking member comprises a lever whereby the locking member is removed from the locking groove.

13. The toner cartridge locking apparatus of claim 1, wherein the locking unit comprises a malleable locking member formed on the toner cartridge; and
a locking groove formed on the toner cartridge housing unit to accommodate the locking member when the toner cartridge is inserted in the toner cartridge housing unit.

14. The toner cartridge locking apparatus of claim 13, wherein the locking member comprises a lever whereby the locking member is removed from the locking groove.

15. An image forming apparatus comprising:
a main body;
a toner cartridge housing unit formed in the main body;
a locking unit to lock a toner cartridge inserted in the toner cartridge housing unit; and
an elastic member to elastically support the toner cartridge inserted in the toner cartridge housing unit in a discharging direction of the toner cartridge.

16. The image forming apparatus of claim 15, wherein:
the main body includes a toner cartridge housing unit; and
the locking unit locks the toner cartridge in place in the toner cartridge housing unit and guides the discharge of the toner cartridge from the toner cartridge housing unit.

17. The image forming apparatus of claim 15, wherein the elastic member is formed in the toner cartridge housing unit.

18. The image forming apparatus of claim 16, wherein the elastic member comprises a conical spring.

19. The image forming apparatus of claim 15, wherein the locking unit comprises:
a guiding groove and a guiding protrusion complementarily formed on the toner cartridge and the toner cartridge housing unit,
wherein the guiding groove comprises an inserting section to insert the guiding protrusion and a locking section extending perpendicular to the inserting section.

20. The image forming apparatus of claim 18, wherein the guiding groove is formed on the toner cartridge, and the guiding protrusion is formed on the toner cartridge housing unit.

21. The image forming apparatus of claim 19, wherein:
the guiding groove is formed on the toner cartridge housing unit, and the guiding protrusion is formed on the toner cartridge.

22. The image forming apparatus of claim 20, wherein the guiding groove is formed on a rotating handle mounted on the toner cartridge.

23. A toner cartridge unit usable with an image forming apparatus, the toner cartridge unit comprising:
a toner cartridge;
a toner cartridge housing unit formed in a main body of an image forming apparatus;
a locking unit to lock a toner cartridge inserted in the toner cartridge housing unit; and
an elastic member to elastically support to elastically support the toner cartridge inserted in the toner cartridge housing unit in a discharging direction of the toner cartridge.

24. The toner cartridge unit of claim 23, wherein:
the toner cartridge includes a toner supply hole to release toner from the toner cartridge to the image forming apparatus;
the toner cartridge housing unit guides the toner cartridge to be mounted in the main body of the image forming apparatus; and
the locking unit locks the toner cartridge inside the toner cartridge housing unit.

25. The toner cartridge unit of claim 23, further comprising:
a rotating handle which disposed on a side opposite the side of the toner cartridge facing the elastic member.

26. The toner cartridge unit of claim 25, wherein the locking unit elastically alternates between a locked position and an unlocked position.

27. The toner cartridge unit of claim 23, wherein the toner cartridge comprises:
a guide projection formed on a portion of a body of the toner cartridge to face the elastic member, the guide projection being inserted into the elastic member.

28. The toner cartridge unit of claim 27, wherein the guide projection has a diameter smaller than an inner diameter of the elastic member.

29. The toner cartridge unit of claim 27, wherein the guide projection has a length longer than a distance of the elastic member in a compressed position.
